(19) United States
(12) Patent Application Publication
(10) Pub. No.: US 2014/0063351 A1
(43) Pub. Date: Mar. 6, 2014

(54) TELEVISION RECEIVER AND ELECTRONIC DEVICE

(71) Applicant: Kabushiki Kaisha Toshiba, Tokyo (JP)

(72) Inventor: Yuki SATO, Ome-shi (JP)

(73) Assignee: Kabushiki Kaisha Toshiba, Tokyo (JP)

(21) Appl. No.: 14/018,672

(22) Filed: Sep. 5, 2013

Related U.S. Application Data
(63) Continuation of application No. PCT/JP2013/060257, filed on Mar. 28, 2013.

(30) Foreign Application Priority Data
Aug. 30, 2012 (JP) 2012-189562

(51) Int. Cl. H04N 5/64

(52) U.S. Cl. CPC H04N 5/64
USPC 348/725; 361/679.01

(57) ABSTRACT

According to one embodiment, a television receiver includes a display, a casing, and a driver board of the display. The display is with a bendable sheet-like shape and includes a front face at which an image is viewable and a rear face opposite the front face. The casing includes: a first wall configured to support the display and cover the rear face, a second wall positioned at a side of the first wall opposite the display and positioned apart from the first wall, and a third wall extending between a periphery of the first wall and a periphery of the second wall. The driver board is provided to the first wall at a side opposite the display. The driver board is electrically connected to the display via a flat cable.

### CROSS-REFERENCE TO RELATED APPLICATIONS

This application is a continuation of PCT international application Ser. No. PCT/JP2013/060257, filed Mar. 28, 2013, which designates the United States, incorporated herein by reference, and which is based upon and claims the benefit of priority from Japanese Patent Application No. 2012-189562, filed Aug. 30, 2012, the entire contents of which are incorporated herein by reference.

### FIELD

Embodiments described herein relate generally to a television receiver and an electronic device.

### BACKGROUND

Conventionally, there has been known an electronic device having a flexible display.

In this kind of electronic device, it is preferable that the electronic device have less inconvenience, such as inconvenience with respect to the layout of driver boards for the flexible display, caused by having the flexible display.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of one example of a television receiver according to a first embodiment;

FIG. 2 is an exemplary side view of one example of the television receiver in the first embodiment;

FIG. 3 is an exemplary schematic cross sectional view of the television receiver taken along a line III-III in FIG. 1, in the first embodiment;

FIG. 4 is an exemplary schematic cross sectional view of a connection part of a second member and a third member of one example of the television receiver in the first embodiment;

FIG. 5 is an exemplary perspective view of one example of an electronic device according to a second embodiment;

FIG. 6 is an exemplary schematic cross sectional view of the electronic device taken along a line VI-VI in FIG. 5, in the second embodiment;

FIG. 7 is an exemplary schematic plan view (front view) of a subassembly including a display of one example of the electronic device, in the second embodiment;

FIG. 8 is an exemplary schematic plan view (rear view) of a first member on which the display of one example of the electronic device is mounted, in the second embodiment;

FIG. 9 is an exemplary cross sectional view of one example of an electronic device according to a first modification of the second embodiment;

FIG. 10 is an exemplary cross sectional view of one example of an electronic device according to a second modification of the second embodiment;

FIG. 11 is an exemplary cross sectional view of one example of an electronic device according to a third modification of the second embodiment;

FIG. 12 is an exemplary cross sectional view of one example of an electronic device according to a fourth modification of the second embodiment;

FIG. 13 is an exemplary cross sectional view of one example of an electronic device according to a fifth modification of the second embodiment;

FIG. 14 is an exemplary cross sectional view of one example of an electronic device according to a sixth modification of the second embodiment;

FIG. 15 is an exemplary schematic plan view (rear view) of a first member on which a display of one example of the electronic device is mounted, in the sixth modification of the second embodiment;

FIG. 16 is an exemplary plan view of one example of an electronic device according to a seventh modification of the second embodiment;

FIG. 17 is an exemplary schematic cross sectional view of the electronic device taken along a line XVII-XVII of FIG. 16, in the seventh modification;

FIG. 18 is an exemplary schematic cross sectional view of the electronic device taken along a line XVIII-XVIII in FIG. 16, in the seventh modification;

FIG. 19 is an exemplary cross sectional view of one example of an electronic device according to a third embodiment;

FIG. 20 is an exemplary perspective view of a first member of one example of the electronic device in the third embodiment;

FIG. 21 is an exemplary cross sectional view of one example of an electronic device according to a first modification of the third embodiment;

FIG. 22 is an exemplary perspective view of a first member of one example of the electronic device in the first modification of the third embodiment;

FIG. 23 is an exemplary perspective view of a first member of one example of an electronic device according to a second modification of the third embodiment;

FIG. 24 is an exemplary perspective view of a first member of one example of an electronic device according to a third modification of the third embodiment;

FIG. 25 is an exemplary perspective view of one example of an electronic device according to a fourth embodiment;

FIG. 26 is an exemplary side view of one example of the electronic device in the fourth embodiment;

FIG. 27 is an exemplary plan view of a first member of one example of the electronic device in the fourth embodiment;

FIG. 28 is an exemplary side view of the first member of one example of the electronic device in the fourth embodiment;

FIG. 29 is an exemplary perspective view of a part of the first member of one example of the electronic device in the fourth embodiment;

FIG. 30 is an exemplary side view of one example of an electronic device according to a first modification of the fourth embodiment;

FIG. 31 is an exemplary side view of one example of an electronic device in a state in which the electronic device is placed on a flat surface in a first posture, according to a second modification of the fourth embodiment;

FIG. 32 is an exemplary side view of one example of the electronic device in a state in which the electronic device is placed on a flat surface in a second posture, in the second modification of the fourth embodiment;

FIG. 33 is an exemplary side view of one example of an electronic device according to a third modification of the fourth embodiment; and

FIG. 34 is an exemplary perspective view of one example of an electronic device according to a fourth modification of the fourth embodiment.

### DETAILED DESCRIPTION

In general, according to one embodiment, a television receiver comprises a display, a casing, and a driver board of the display. The display is with a bendable sheet-like shape and comprises a front face at which an image is viewable and a rear face opposite the front face. The casing comprises: a first wall configured to support the display and cover the rear face; a second wall positioned at a side of the first wall opposite the display and positioned apart from the first wall; and a third wall extending between a periphery of the first wall and a periphery of the second wall. The driver board is provided to the first wall at a side opposite the display. The driver board is electrically connected to the display via a flat cable.

A plurality of exemplary embodiments and modifications described below include configuration elements similar to each other. Therefore, in the following descriptions, the configuration elements similar to each other are given same numerals and their repeated explanations are partially omitted. Furthermore, in the following embodiments and modifications, although an electronic device is exemplified as a television receiver or what is called a tablet-type (slate-type) personal computer, the electronic device according to the present embodiments is not limited to these examples. The electronic device in the present embodiments can be configured as various kinds of electronic devices each capable of mounting a flexible display, such as a notebook-type (a clamshell-type) personal computer, a smart phone, a smartbook, a mobile phone, a personal digital assistant (PDA), a video display device, a monitoring device, or a videophone.

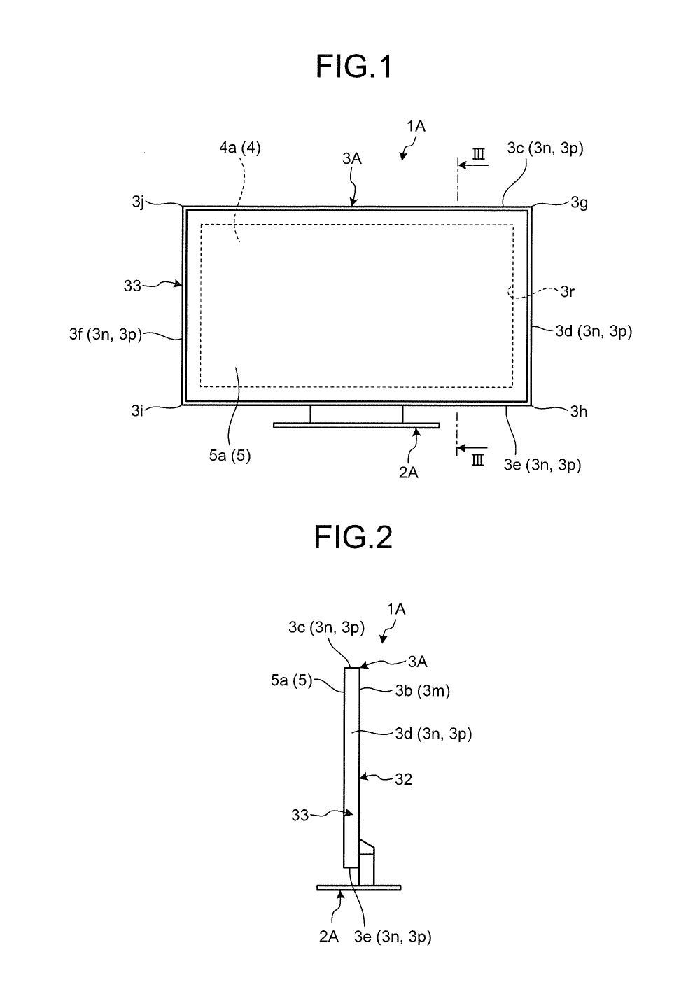

In a first embodiment illustrated in FIGS. 1 to 4, as one example, a television receiver 1A as one example of an electronic device is provided with a support base 2A (a support, a base, a stand) and a casing 3A. To be more specific, the support base 2A is placed on a placement portion (a placing surface, not illustrated in the drawings) such as a desk, a shelf, or a base and supports the casing 3A in a state in which the casing 3A is stood up. The support base 2A may fixedly support the casing 3A or support the casing 3A in a movable manner (a rotatable manner, a slidable manner). As a moving form (rotating form) of the casing 3A relative to the support base 2A, for example, tilting, swiveling, and pivoting are designated.

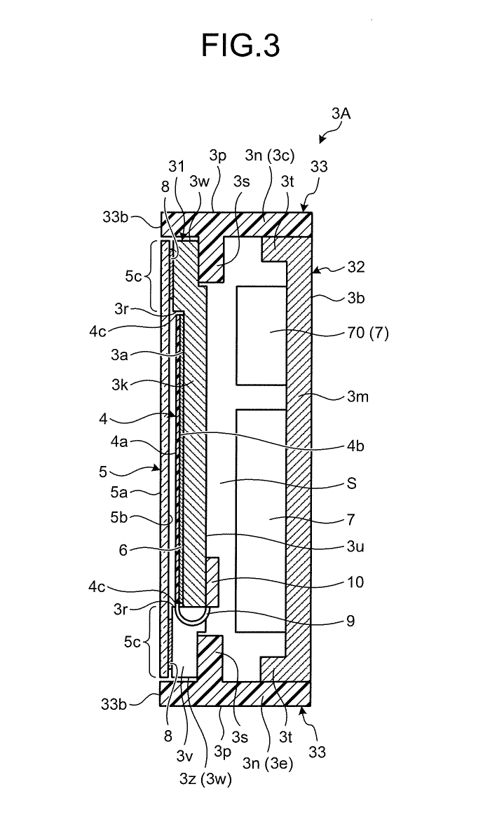

Furthermore, in the present embodiment, as one example illustrated in FIG. 1, the casing 3A has the external appearance of a quadrangular shape (a laterally long rectangular shape as one example in the present embodiment) as viewed in a front view and a rear view. As illustrated in FIGS. 2 and 3, the casing 3A is formed in a thin flat rectangular parallelepiped shape in the anterioposterior direction (in the thickness direction of the casing 3A, in the lateral direction in FIG. 2). The casing 3A has a face 3a (a front face, a front surface, a surface portion), a face 3b (a rear face, a back face, a surface portion) opposite to the face 3a, and a face 3p (a side face, a surface portion) extending between the face 3a and the face 3b. Both the faces 3a and 3b intersect with the thickness direction of the casing 3A. The face 3a and the face 3b are arranged substantially in parallel to each other. Furthermore, the face 3a (3b) and the face 3p intersect with each other (orthogonal to each other as one example in the present embodiment). In addition, as illustrated in FIG. 1, the casing 3A has four end portions 3c to 3f (side portions, edge portions, periphery portions) and four corner portions 3g to 3j (convex portions, bending portions, end portions) as viewed in a front view. Each of the end portions 3c and 3e is one example of a width side of the casing 3A. Each of the end portions 3d and 3f is one example of a length side of the casing 3A.

Furthermore, the casing 3A has a wall 3k (a part, a plate, a front wall, a front surface wall, a top wall, a first wall), a wall 3m (a part, a plate, a rear wall, a back wall, a bottom wall, a second wall), and a wall 3n (a part, a plate, a side wall, an end wall, a vertical wall, a connecting portion, a third wall). The wall 3k has the face 3a. The wall 3m has the face 3b. The wall 3n has the face 3p. Each of the walls 3k, 3m, and 3n is formed in a quadrangular shape (a rectangular shape as one example in the present embodiment). In addition, each of the walls 3k, 3m, and 3n is formed in a plate shape. The wall 3k is provided with a quadrangular opening 3r (a recessed portion as one example in the present embodiment). In the present embodiment, as one example, a display 4 is housed in the opening 3r. The face 3a of the wall 3k and the display 4 are covered with a member 5 (a plate, a wall part, a cover, a protection part). A space is formed between the wall 3k and the wall 3m.

In addition, the casing 3A is configured by a plurality of components (divided bodies, members) combined with each other. The casing 3A has, as one example, a member 31 (a front side member, a cover, a bezel, a plate, a first member), a member 32 (a rear side member, abase, a bottom, a plate, a second member), and a member 33 (a side member, a side cover, a plate, a third member). The member 31 includes the wall 3k. The member 32 includes the wall 3m. The member 33 includes the wall 3n. Each of the members 31, 32, and 33 can be composed of a metallic material, a synthetic-resin material, or the like. In the present embodiment, as one example, the member 31 and the member 32 are composed of metallic materials. The member 33 is composed of a synthetic-resin material. However, the materials of the members are not limited to these materials. The metallic material can be made by casting, pressing, cutting, or the like. The synthetic-resin material can be made by injection molding or the like.

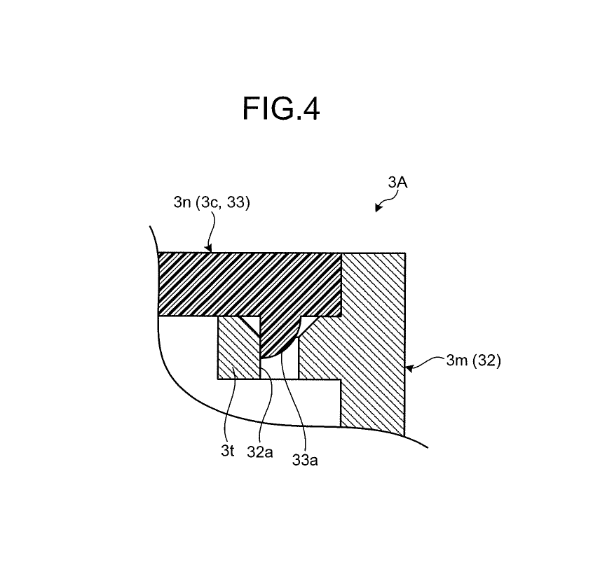

A plurality of components (the members 31, 32, 33, or the like as one example in the present embodiment) by which the casing 3A is configured are joined each other by fastening using fasteners (a screw or a clip, for example), hooking using concave-convex structures (convex and concave periphery portions, for example), bonding, welding, or the like. As one example, the member 32 has a projecting portion 3t. Inside the casing, the projecting portion 3t projects from the wall 3m along the surface of the wall 3n. As illustrated in FIG. 4, the periphery portion of a hooking portion 32a (an opening) provided to the projecting portion 3t and a hooking portion 33a (a projecting portion, a convex portion, a claw portion) provided to the wall 3n are hooked each other in the thickness direction of the casing 3A (in the lateral direction in FIG. 4). The member 31 and the member 33 are joined each other by hooking (snap-fit) between the periphery portion of the hooking portion 32a and the hooking portion 33a. Furthermore, as another example, the member 33 (the wall 3n) has a projecting portion 3s. The projecting portion 3s projects from the wall 3n toward the inside of the casing 3A. The projecting portion 3s and the periphery portion (the end portion) of the wall 3k are overlapped with each other in the thickness direction of the casing 3A. Furthermore, the projecting portion 3s and the periphery portion of the wall 3k are joined each other by fasteners (screws or the like, not illustrated in the drawings), for example. The projecting portion 3s is located at the periphery portion of the wall 3k in the inside of the casing 3A (a rear side, a right side in FIG. 3). The fastener is inserted into a through hole and a female screw hole (each not illustrated in the drawings) for joining the projecting portion 3s and the wall 3k. The projecting portion 3s may be provided extending over the whole circumference of the member 33, or may be partially provided.

The display 4 (a display module, a display device, a component) covers the face 3a of the wall 3k. In the present embodiment, as one example, the display 4 is formed to be flexible, soft, bendable, thin, and in a sheet-like (film-like) shape. The display 4 is, for example, a liquid crystal display (LCD) or an organic electroluminescent display (OELD). The display 4 is formed in a quadrangular shape (a rectangular shape as one example in the present embodiment) as viewed in the thickness direction (as viewed in a plan view). The display 4 has a face 4a (a front face, a front, an upper face, a surface, a screen, a display screen) at which images are viewable and a face 4b (a rear face, a back face, a bottom face, a reverse face) opposite the face 4a. Here, the bendable display 4 means that the display 4 is capable of being bent independently, and does not necessarily mean that the display 4 is capable of being bent in a state that the display 4 is set in the casing 3A. Whether or not the display 4 is bent in a state that the display 4 is set in the casing 3A depends on the configuration, the rigidity, or the like of the casing 3A. In the present embodiment, as one example, the display 4 is capable of being bent independently whereas the display 4 is not bent in a state that the display 4 is set in the casing 3A.

The member 5 covers the face 3a of the wall 3k and the face 4a of the display 4. The member 5 (the cover, the plate, the protection part) is comparatively high in rigidity and formed in a thin plate-like shape. The member 5 can be, for example, composed of a glass material, a transparent synthetic-resin material (acrylic material, for example). The member 5 is thicker than the display 4. The member 5 has a face 5a (a front face, a front, a surface part) and a face 5b (a back face, a rear face, a surface portion) opposite the face 5a. The face 5a is exposed on the front face side (the front side) of the casing 3A. Furthermore, at least the area of the member 5 that is located in front of the display 4 is transparent (transparent and colorless as one example in the present embodiment). On the other hand, an area 5c of the member 5 that is located on the outer side of a periphery portion 4c of the display 4 is colored in comparatively dark color (black, dark blue, brown, or the like), or covered with an opaque or less-translucent member. That is, as viewed from the front side (the left side, the front face side, the front side in FIG. 3) of the face 5a of the member 5, it is impossible to visually identify the rearward (the right side, the rear face side, the back side in FIG. 3) of the periphery portion of the member 5.

Furthermore, the face 5b of the member 5 is provided with a touch sensor (a touch panel, an operation panel, an input operation module, not illustrated in the drawings). The touch sensor covers the face 4a of the display 4. Operators (users) touch, push, or rub the surface 5a of the member 5 with their fingers or a stylus, or move their fingers or the stylus in the vicinity of the face 5a thus performing input processing. Here, the touch sensor is also transparent (transparent and colorless).

A member 6 (an adhesive portion, a buffer portion, a holding portion, an interposing portion) is located (sandwiched, interposed) between the wall 3k and the display 4. Furthermore, a member 8 (an adhesive portion, a buffer portion, a holding portion, an interposing portion) is located (sandwiched, interposed) between the wall 3k and the member 5. The members 6 and 8 can be, as one example, double-stick tapes. In addition, the member 6 is low in thermal conductivity relative to the wall 3k (the member 31). The member 6 suppresses heat transfer between the display 4 and the member 31 or components 7. That is, the member 6 is one example of an adiabatic material (a heat insulation material, a heat transfer suppression part, a suppression part). As one example, the member 6 can suppress the heat transfer from the components 7 (a board assembly 70, for example) to the display 4.

In the present embodiment, as one example illustrated in FIG. 3, each of the display 4, the member 5, and the like is supported by the wall 3k (the member 31). Furthermore, in the present embodiment, as one example, end portions 33b (faces, end faces) on the front sides of the wall portions 3n (the members 33) are aligned in the direction along the face 5a (the front face, the surface) of the member 5 and in line with the face 5a. In addition, in the present embodiment, as one example, the face 3a of the wall 3k is overlapped with the face 4a of the display 4, and the face 3a and the face 4a are covered with the member 5.

The casing 3A is provided with a housing chamber S (a chamber, a space) surrounded by the walls 3k, 3m, and 3n. The housing chamber S is located between the wall 3k and the wall 3m, extended between the end portion 3c and the end portion 3e, and extended between the end portion 3d and the end portion 3f. The components 7 are housed in the inside of the space. The component 7 is, for example, a battery, a board (a circuit board, a control board, a sub board), various kinds of modules, an optical disk drive (ODD), a hard disk drive (HDD), a solid state drive (SSD), an antenna, a camera module, a speaker unit, a connector unit, an operation unit (a switch), a sensor unit, or the like. However, the component 7 is not limited to these components.

Furthermore, in the present embodiment, as one example, the board assembly 70 including boards in the inside of the housing chamber S mounts thereon a plurality of components (components, elements, electronic components, electric components, not illustrated in the drawings) such as a central processing unit (CPU). The components include an exothermic body. The component with large calorific power (the exothermic body) can be provided with a cooling mechanism (a heat dissipater, a heat receiver, not illustrated in the drawings). At least a portion of the control circuit (not illustrated in the drawings) is configured of boards, components, or the like. The control circuit can, for example, comprise a video signal processing circuit, a tuner module, a high-definition multimedia interface (HDMI), a signal processing module, an audio video (AV) input terminal, a remote control signal receiver, a controller, a selector, an onscreen display interface, a storage module (a read only memory (ROM), a random access memory (RAM), a hard disk drive (HDD), for example), an audio signal processing circuit, or the like. The control circuit controls the output of videos (moving pictures, still pictures, or the like) displayed on the face 4a of the display 4, the output of sounds from a speaker (not illustrated in the drawings), the emission of light beams from light emitting diodes (LEDs, not illustrated in the drawings), or the like. The display 4, the speaker, the LED, or the like is one example of an output module.

Furthermore, in the present embodiment, as one example illustrated in FIG. 3, the display 4 is electrically connected with a driver board 10 (a drive board, a control board, a board) via a flat cable 9 (a wiring module, a wiring board, a wiring board module, a strip-like wiring module). In the present embodiment, as one example, the flat cable 9 is formed to be flexible, soft, bendable, thin, and in a sheet-like (film-like), and strip-like shape. The flat cable 9 can be, as one example, configured as a flexible printed circuit (FPC) board. When the flat cable 9 is the FPC board, the flat cable 9 has elasticity. That is, the flat cable 9 can be elastically deformed (elastically bent). Furthermore, the flat cable 9 has a plurality of parallel conductor modules (wiring modules, conductor patterns) in the inside thereof. The conductor module is covered with an insulative film. The driver board 10 has a circuit or the like that drives an electrode (an X electrode, a Y electrode, a source electrode, a gate electrode, or the like) of each dot of the display 4. The flat cable 9 can be joined (connected, fixed) to the driver board 10 by soldering, welding, or the like, and detachably joined (connected) to the driver board 10 by way of a connector (not illustrated in the drawings). In addition, the flat cable 9 can be joined (connected, fixed) to the display 4 by thermo-compression bonding, soldering, or the like.

The driver board 10 is positioned to the wall 3k at a side opposite the display 4, and attached to a face 3u opposite the face 3a. The driver board 10 is fixed (joined, connected) to the wall 3k by fastening using fasteners (screws, for example), bonding, or the like. Furthermore, the wall 3k is provided with an opening 3v (a through hole, a notch, a slit, or the like). In the present embodiment, as one example, the opening 3v is provided as the notch of an end portion 3z (a periphery portion 3w) of the wall 3k. The flat cable 9 passes through the opening 3v. The opening 3v is partially provided at a position corresponding to the flat cable 9 in the periphery portion 3w.

The flexible sheet-like display 4 is small in thickness compared with a conventional panel-type display thus obtaining the effect that the casing 3A becomes small in thickness as a whole. However, the display 4 is comparatively low in rigidity and easily bent and hence, when the display 4 is not provided with equipment for maintaining the face 4a in a planar shape, there exists a possibility that the display 4 has poor viewability. Furthermore, when the driver board 10 is located on the face 4b of the display 4 and the display 4 covers the driver board 10 on the face 3a side of the wall 3k, because the display 4 has flexibility, there exists a possibility that a portion of the display 4 that is corresponding to the driver board 10 is raised (bulges, projects, deformed in steps) frontward. In addition, it is difficult for the display 4 to independently have rigidity required for supporting the driver board 10.

Herein, in the present embodiment, as one example, the display 4 is located on the face 3a side of the wall 3k, the driver board 10 is located on the face 3u side of the wall 3k, and the flat cable 9 passing through the opening 3v electrically connects the display 4 and the driver board 10. Therefore, according to the present embodiment, as one example, the display 4 is easily held in a flattened state. Therefore, as one example, the viewability of the display 4 is easily improved. Furthermore, the inconvenience attributed to the unevenness of the display 4 caused by covering the driver board 10 with the display 4 does not arise. Furthermore, a subassembly in which the display 4 and the driver board 10 are mounted on the wall 3k (the member 31) can be configured thus easily reducing times and efforts or costs for the manufacturing (assembling), the maintenance, or the like of the television receiver 1A (the electronic device). In addition, the opening 3v is provided to the wall 3k and hence, the flat cable 9 is more easily arranged compared with the case that the opening 3v is not provided.

An electronic device 1B according to a second embodiment is what is called a slate-type or tablet-type personal computer provided with a display device having the function of a software keyboard, a television receiver, a smart phone, a smartbook, a mobile phone, a PDA, or the like.

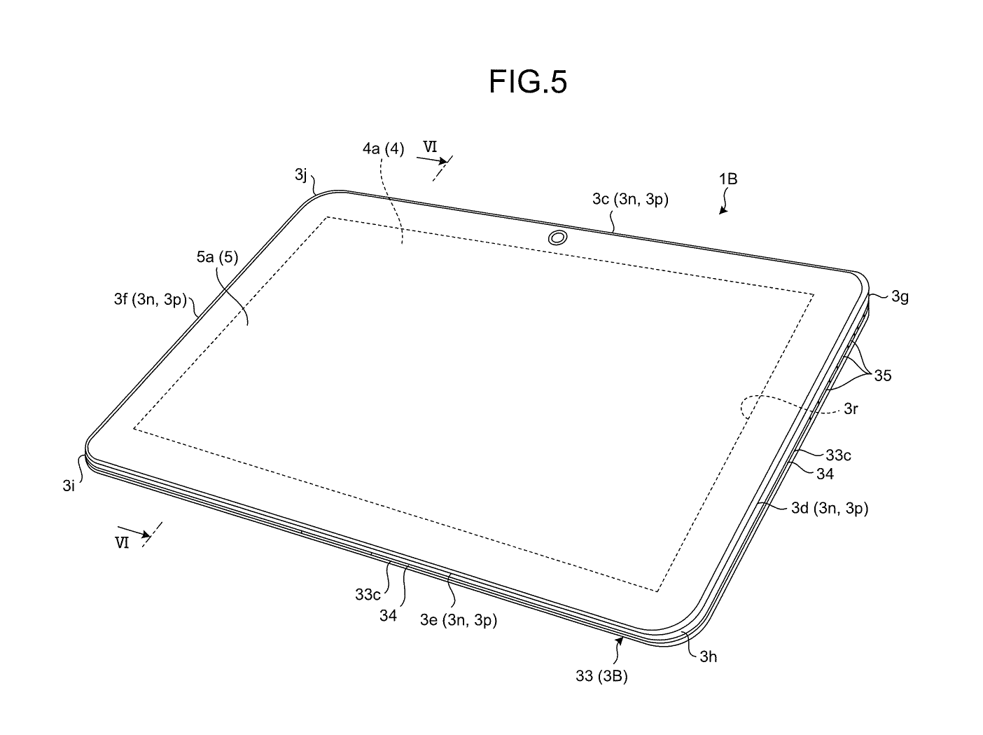

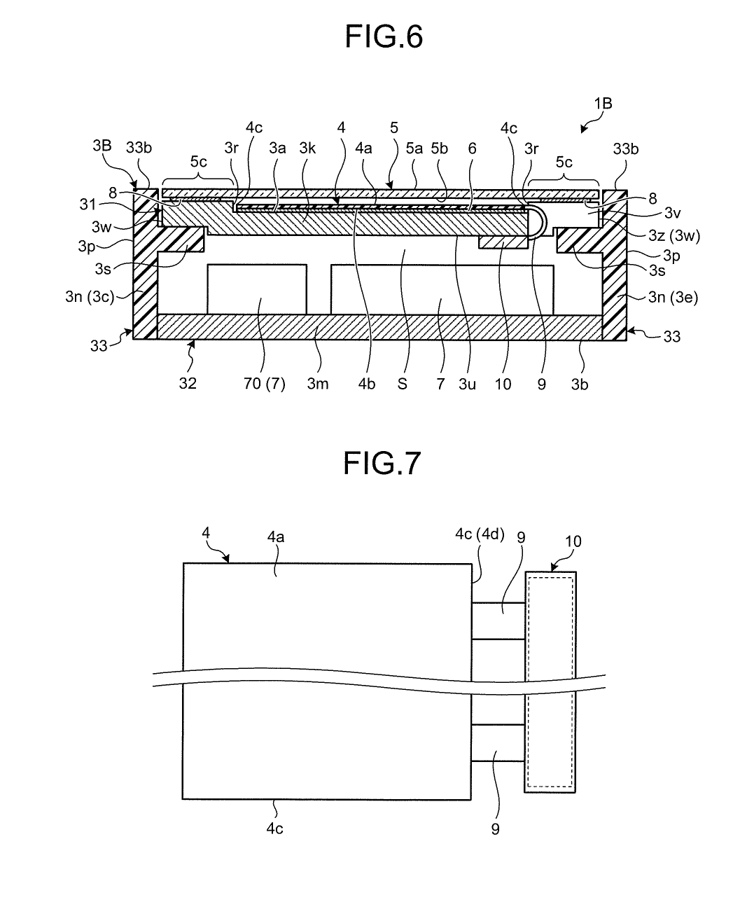

In the present embodiment, as one example, as can be understood from FIG. 5, a casing 3B of the electronic device 1B has the external appearance of a quadrangular shape (a rectangular shape as one example in the present embodiment) as viewed in a front view and a rear view. Furthermore, as illustrated in FIG. 6, the casing 3B is formed in a thin flat rectangular parallelepiped shape in the anterioposterior direction (in the thickness direction of the casing 3B). The casing 3B has a face 3a (a front face, a front surface, a surface portion), a face 3b (a rear face, a back face, a surface portion) opposite the face 3a, and a face 3p (a side face, a surface portion) extending between the face 3a and the face 3b. Both the faces 3a and 3b intersect with the thickness direction of the casing 3B. The face 3a and the face 3b are arranged substantially in parallel to each other. Furthermore, the face 3a (3b) and the face 3p intersect with each other (orthogonal to each other as one example in the present embodiment). In addition, as illustrated in FIG. 5, the casing 3B has four end portions 3c to 3f (side portions, edge portions, periphery portions) and four corner portions 3g to 3j (convex portions, bending portions, end portions) as viewed in a front view. Each of the end portions 3c and 3e is one example of the width side of the casing 3B. Each of the end portions 3d and 3f is one example of the length side of the casing 3B.

Furthermore, the casing 3B has a wall 3k (a part, a plate, a front wall, a front surface wall, a top wall, a first wall), a wall 3m (a part, a plate, a rear wall, a back wall, a bottom wall, a second wall), and a wall 3n (a part, a plate, a side wall, an end wall, a vertical wall, a connecting portion, a third wall). The wall 3k has the face 3a. The wall 3m has the face 3b. The wall 3n has the face 3p. Each of the walls 3k, 3m, and 3n is formed in a quadrangular shape (a rectangular shape as one example in the present embodiment). In addition, each of the walls 3k, 3m, and 3n is formed in a plate shape. The wall 3k is provided with a quadrangular opening 3r (a recessed portion as one example in the present embodiment). In the present embodiment, as one example, a display 4 is housed in the opening 3r. The face 3a of the wall 3k and the display 4 are covered with a member 5 (a plate, a wall, a cover, a protector). A space is defined between the wall 3k and the wall 3m.

In addition, the casing 3B is configured of a plurality of components (divided bodies, members) combined with each other. The casing 3B has, as one example, a member 31 (a front side member, a cover, a bezel, a plate, a first member), a member 32 (a rear side member, a base, a bottom, a plate, a second member), and a member 33 (a side member, a side cover, a plate, a third member). The member 31 includes the wall 3k. The member 32 includes the wall 3m. The member 33 includes the wall 3n. Each of the members 31, 32, and 33 can be, for example, composed of a metallic material, a synthetic-resin material, or the like. In the present embodiment, as one example, the member 31 and the member 32 are composed of metallic materials. The member 33 is composed of a synthetic-resin material. However, the materials of the members are not limited to these materials. The metallic material can be, for example, made by casting, pressing, cutting, or the like. The synthetic-resin material can be, for example, made by injection molding or the like.

Furthermore, as illustrated in FIG. 5, the middle portion (the center portion) of the outer surface of the wall 3n in the thickness direction is provided with a groove 33c (a recessed portion) extending along the end portions 3c to 3f. Furthermore, at least a portion of the groove 33c houses (embeds) a member 34 extending along the groove 33c therein. The wall 3n and the member 34 can be changed in material or color. When the member 34 is configured of a member being more rigid than the wall 3n, as one example, the wall 3n is reinforced. On the other hand, when the member 34 is configured of a member being more flexible than the wall 3n (an elastic member, for example), the elasticity (flexibility) of the wall 3n is improved and, as one example, shock absorption of the wall 3n is easily improved. Furthermore, the groove 33c is provided with an operation portion 35 such as a switch partially in place of the member 34. As a switch for the operation portion 35, a power switch, a volume control switch, a reset switch, or the like can be designated. The projection height of the member 34 and the operation portion 35 from the wall 3n can be made identical. Due to such a configuration, the operation portion 35 becomes inconspicuous apparently. In addition, the member 34 and the operation portion 35 are sequentially arranged thus easily improving the appearance thereof.

In the present embodiment, as one example illustrated in FIGS. 5 and 6, in front of the wall 3k of the casing 3B, the display 4 (a display module, a display device, a component) is arranged. A structure in which the casing 3B supports the display 4, the member 5, a member 6, and the like is the same as in the first embodiment. Furthermore, the display 4 and the members 5 and 6 per se are also basically the same as in the first embodiment except for some specifications such as size.

In the present embodiment, as one example, a board assembly 70 including a board (not illustrated in the drawings) mounts thereon a plurality of components (not illustrated in the drawings) such as a central processing unit (CPU), a graphics controller, power circuits, a platform controller hub (PCH), a memory slot connector, an LCD connector, an input/output (I/O) connector, a power supply coil, elements, and connectors. These components include heat generating bodies. It is possible to equip the board assembly 70 with a cooling device (a cooling mechanism, not illustrated in the drawings). Furthermore, at least a portion of a control circuit (not illustrated in the drawings) is configured by a board, components, or the like. In addition, the control circuit can, for example, comprise a video signal processing circuit, a tuner module, a high-definition multimedia interface (HDMI) signal processor, an audio video (AV) input terminal, a remote control signal receiver, a controller, a selector, an on-screen display interface, a storage module (a read only memory (ROM), a random access memory (RAM), a hard disk drive (HDD), or the like), an audio signal processing circuit, and the like. The control circuit controls the output of videos (moving pictures, still pictures, or the like) displayed on the face 4a of the display 4, the output of sounds from a speaker (not illustrated in the drawings), the emission of light beams from light emitting diodes (LEDs, not illustrated in the drawings), or the like. The display 4, the speaker, the LEDs, or the like is one example of an output module.

Furthermore, in the present embodiment, as one example illustrated in FIGS. 6 and 7, the display 4 is electrically connected with a driver board 10 (a drive board, a control board, a board) via a flat cable 9 (a wiring module, a wiring board, a wiring board module, a strip-like wiring module). In the present embodiment, as one example, the flat cable 9 is formed to be flexible, soft, bendable, thin, and in a sheet-like (film-like), and strip-like shape. The flat cable 9 can be, as one example, configured as a flexible printed circuit (FPC) board. The flat cable 9 has a plurality of parallel conductors (wirings, conductor patterns) inside thereof. The conductors are covered with an insulative film. The driver board 10 has a circuit or the like that drives an electrode (an X electrode, a Y electrode, a source electrode, a gate electrode, or the like) of each dot of the display 4. The flat cable 9 can be joined (connected, fixed) to the driver board 10 by soldering, welding, or the like, and detachably joined (connected) to the driver board 10 by way of a connector (not illustrated in the drawings). In addition, the flat cable 9 can be joined (connected, fixed) to the display 4 by thermocompression, soldering, or the like.

The driver board 10 is positioned to the wall 3k at a side opposite the display 4, and attached to a face 3u opposite the face 3a. The driver board 10 is fixed (joined, connected) to the wall 3k by fastening using fasteners (screws, for example), bonding, or the like. Furthermore, the wall 3k is provided with an opening 3v (a through hole, a notch, a slit, or the like). In the present embodiment, as one example, the opening 3v is provided as the notch of an end portion 3z (a periphery portion 3w) of the wall 3k. The flat cable 9 passes through the opening 3v. The opening 3v is partially provided at a position corresponding to the flat cable 9 in the end portion 3z (the periphery portion 3w).

Furthermore, in the present embodiment, as one example illustrated in FIG. 7, a plurality of the flat cables 9 (two cables, as one example in the present embodiment) are projected from an end portion 4d (a periphery portion 4c) of the display 4. The flat cable 9 extends in the direction intersecting with the end portion 4d (in the direction orthogonal to the end portion 4d, as one example in the present embodiment). A side of the flat cable 9 opposite the display 4 is connected to the driver board 10. The driver board 10 extends along the end portion 4d of the display 4 in parallel with the end portion 4d and in a strip-like shape.

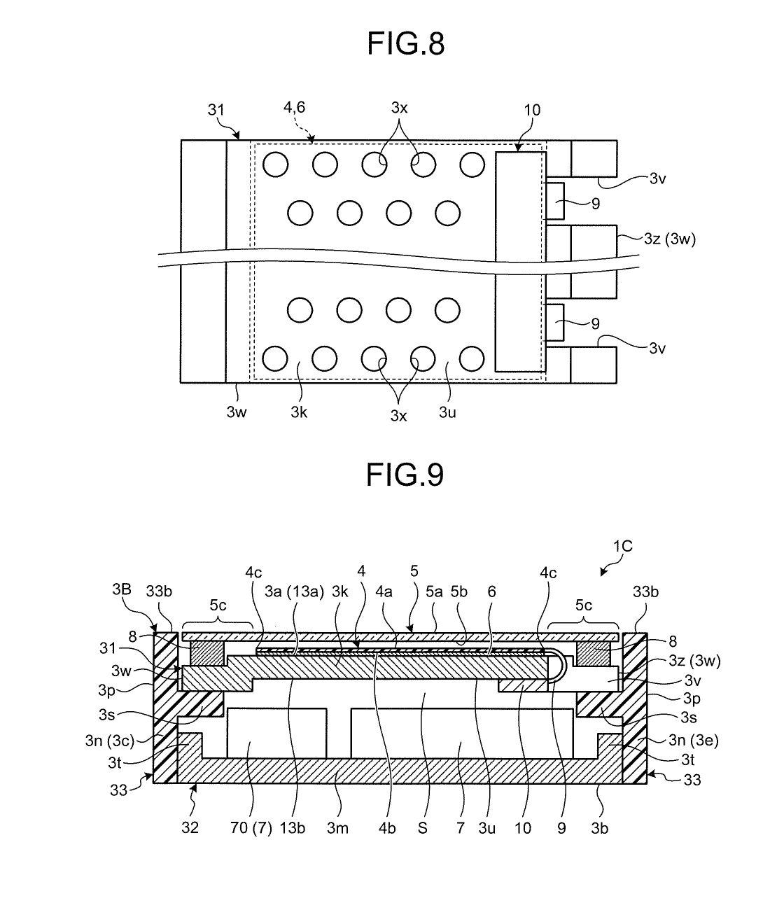

In the present embodiment, as one example illustrated in FIG. 8, the wall 3k (the member 31) is provided with a plurality of openings 3x (recessed portions, through holes, or the like). In the present embodiment, as one example, the opening 3x is a circular through hole, and provided to an area overlapping with the display 4. However, the opening 3x is not provided to an area of the wall 3k on which the driver board 10 is mounted. Due to the openings 3x, as one example, the wall 3k as well as the electronic device 1B is easily reduced in weight. Furthermore, due to the openings 3x, as one example, the surface area of the wall 3k is easily increased and the air permeability of the wall 3k is easily improved. In addition, the end portion 3z (the periphery portion 3w) of the wall 3k is provided with a plurality of openings 3v corresponding to the flat cables 9.

The electronic device 1B according to the second embodiment can also obtain substantially the same advantageous effects as the above-mentioned advantageous effects because the electronic device 1B has substantially the same configuration as in the configuration of the television receiver 1A according to the first embodiment.

An electronic device 1C according to a first modification of the second embodiment illustrated in FIG. 9 provides substantially the same configuration as in the above-mentioned embodiments or modifications. Therefore, due to the present modification also, it is possible to obtain substantially the same manner of operation and results (advantageous effects) based on substantially the same constitution. However, in the present modification, the configuration of the wall 3k differs from the above-mentioned embodiment. That is, the center portion (the intermediate portion) of the wall 3k is provided with a projecting portion 13a projecting frontward (a display 4 side, upwardly in FIG. 9). A display 4 and a member 6 are supported on the projecting portion 13a. Furthermore, a side of the projecting portion 13a that is opposite the display 4 is provided with a recessed portion 13b. A driver board 10 is housed in the recessed portion 13b. The driver board 10 is located close to the end portion of the recessed portion 13b. Therefore, the driver board 10 is easily positioned. According to the present modification, because the wall 3k has uneven surface, the rigidity of the wall 3k is easily improved. Furthermore, in the present modification, a projection portion 3t projects from the wall 3m along the surface of the wall 3n that faces the inside of the casing. The projecting portion 3t extends along the periphery portion of the wall 3m. Therefore, the rigidity of the side wall (the wall 3n) of the casing 3B is more easily improved at portions where the projecting portion 3t and the wall 3n overlap each other.

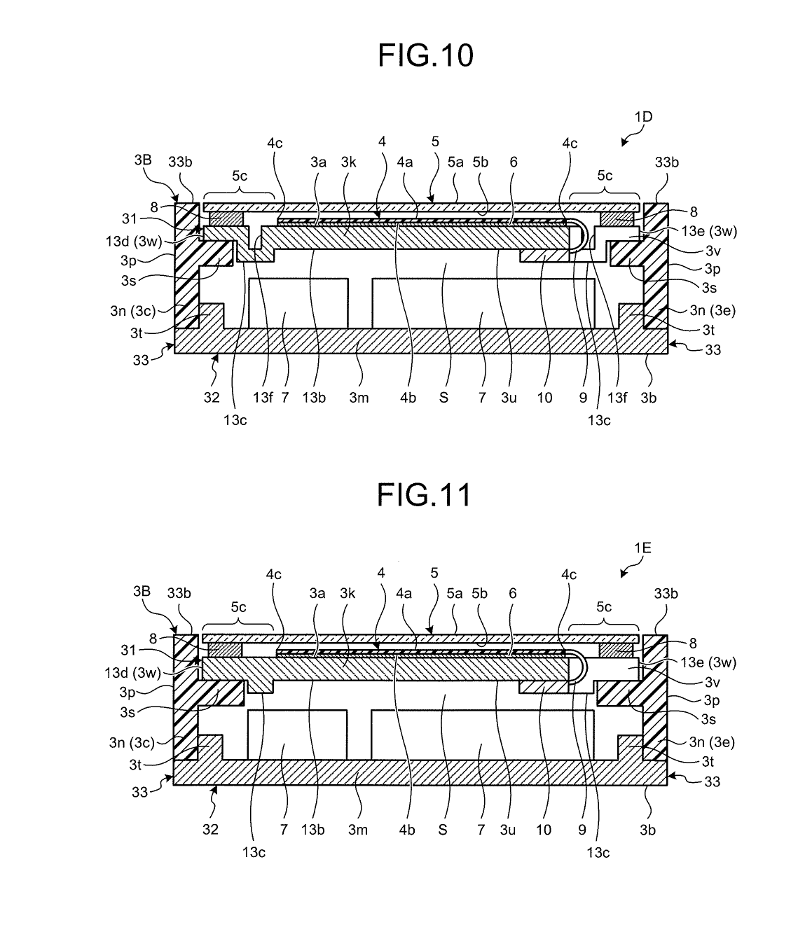

An electronic device 1D according to a second modification of the second embodiment illustrated in FIG. 10 provides substantially the same configuration as in the above-mentioned embodiments or modifications. Therefore, due to the present modification also, it is possible to obtain substantially the same manner of operation and results (advantageous effects) based on substantially the same constitution. However, in the present modification, the configuration of the wall 3k differs from the above-mentioned embodiment or modification. That is, the end portion of the wall 3k is provided with a projecting portion 13c projecting rearward (to a side opposite the display 4, toward inside of the casing, downwardly in FIG. 10). The projecting portion 13c is provided to each of two end portions 13d and 13e (the periphery portion 3w) opposite each other out of four end portions of the wall 3k. The projecting portion 13c extends along each of the end portions 13d and 13e. Recessed portions 13f (groove portions) are provided to a side (a display 4 side, a front side) opposite the projecting portions 13c. A driver board 10 is located close to the end portion of the recessed portion 13b. Therefore, the driver board 10 is easily positioned. According to the present modification, because the wall 3k has an uneven surface, the rigidity of the wall 3k is easily improved. Furthermore, the recessed portion 13f can be used as a space for placing cables (harnesses) or the like. In contrast, when the thickness of the projecting portion 13c is properly reduced, it is possible to provide elasticity (flexibility) to the projecting portion 13c of the wall 3k thus easily bending or vibrating the wall 3k.

An electronic device lE according to a third modification of the second embodiment illustrated in FIG. 11 provides substantially the same configuration as in the above-mentioned embodiments or modifications. Therefore, due to the present modification also, it is possible to obtain substantially the same manner of operation and results (advantageous effects) based on substantially the same constitution. However, in the present modification, the configuration of the wall 3k differs from the above-mentioned embodiment or modifications. That is, the end portion of the wall 3k is provided with a projecting portion 13c projecting rearward (to a side opposite the display 4, toward inside of the casing, downwardly in FIG. 11). The projecting portion 13c is provided to each of two end portions 13d and 13e opposite each other out of four end portions of the wall 3k. The projecting portion 13c extends along each of the end portions 13d and 13e. The projecting portion 13c projects in a wall-like shape, and a recessed portion is not provided to a side (a front side) opposite thereto. A driver board 10 is located close to the end portion of the recessed portion 13b. Therefore, the driver board 10 is easily positioned. According to the present modification, because the wall 3k has convex portions, the rigidity of the wall 3k is easily improved.

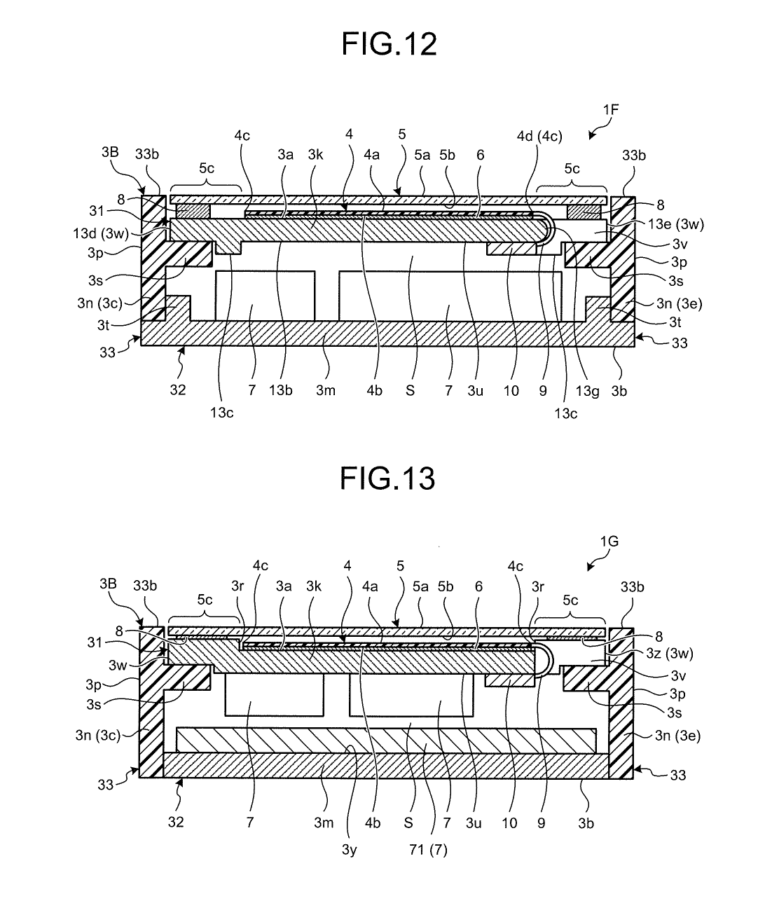

An electronic device 1F according to a fourth modification of the second embodiment illustrated in FIG. 12 provides substantially the same configuration as in the above-mentioned embodiments or modifications. Therefore, due to the present modification also, it is possible to obtain substantially the same manner of operation and results (advantageous effects) based on substantially the same constitution. However, in the present modification, the configuration of the wall 3k differs from the above-mentioned embodiment or modifications. That is, a rounded portion 13g (curve, curved portion) formed in a shape corresponding to a curvature of a flat cable 9 is provided to the edge of an opening 3v. The rounded portion 13g extends between a face 3a and a face 3u, and projects in the direction along the face 3a or the face 3u and intersecting with the end portion 4d of a display 4 (in the direction orthogonal to the end portion 4d of the display 4, as one example in the present modification). The outer circumference of the rounded portion 13g is formed in a semicircle-like shape as viewed in a cross-sectional view. The flat cable 9 can be inflected along the face of the rounded portion 13g. Therefore, according to the present modification, the flat cable 9 is easily prevented from being damaged by the interference of the flat cable 9 with the edge of the opening 3v.

An electronic device 1G according to a fifth modification of the second embodiment illustrated in FIG. 13 provides substantially the same configuration as in the above-mentioned embodiments or modifications. Therefore, due to the present modification also, it is possible to obtain substantially the same manner of operation and results (advantageous effects) based on substantially the same configuration. However, in the present modification, the arrangement of components 7 inside a casing 3B differs from the above-mentioned embodiment or modifications. That is, the components 7 are mounted on the face 3u of a wall 3k opposite a display 4. Furthermore, the components 7 are also mounted on a face 3y of a wall 3m. Due to such a configuration, it is possible to arrange comparatively small components 7 (small or narrow as viewed in a plan view (as viewed in the thickness direction of the casing 3B)) on the face 3u narrower than the face 3y and arrange comparatively large components 7 (large or wide as viewed in a plan view) on the face 3y larger than the face 3u. The use of the wall 3k allows to easily arrange the components 7 more effectively in the housing chamber S of the casing 3B. One example of the comparatively large components 7 is a battery 71 (a battery module, a battery pack, a cell).

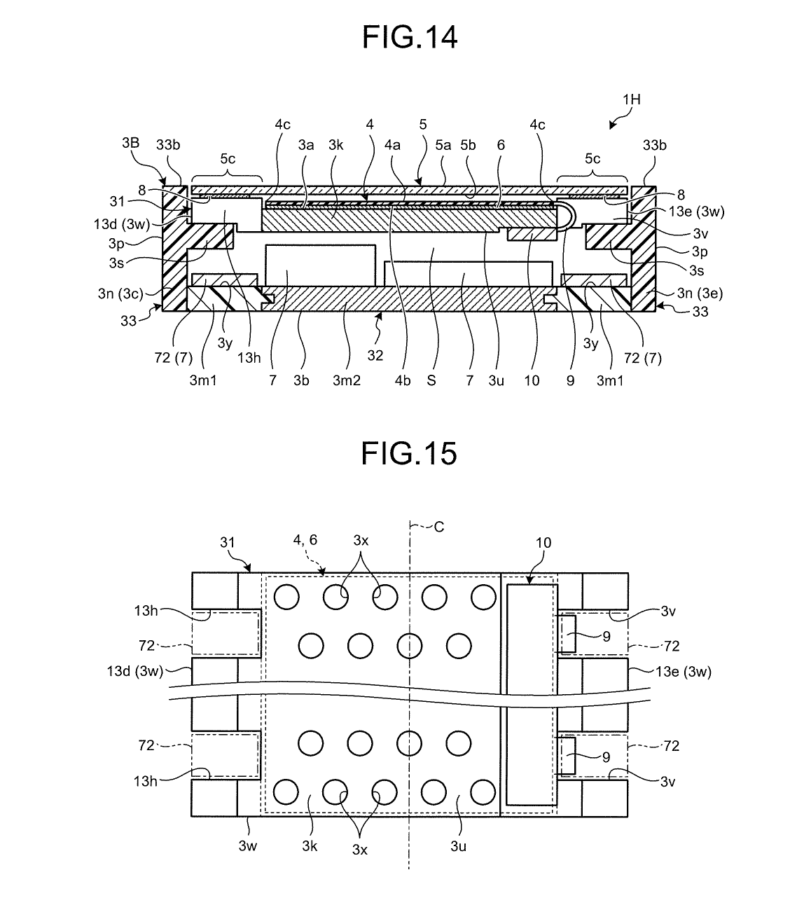

An electronic device 1H according to a sixth modification of the second embodiment the present modification illustrated in FIGS. 14 and 15 provides substantially the same configuration as in the above-mentioned embodiments or modifications. Therefore, due to the present modification also, it is possible to obtain substantially the same manner of operation and results (advantageous effects) based on substantially the same configuration. However, in the present modification, the configuration of walls 3k and 3m and the arrangement of antennas 72 (antenna modules, components 7) differ from the above-mentioned embodiment or modifications. That is, the antennas 72 are mounted on the face 3y of the wall 3m. The antenna 72 can be an antenna compliant with various kinds of communication methods (a wireless local area network (a wireless LAN), a third generation mobile communication system (a 3G), long term evolution (LTE), a global positioning system (a GPS), television broadcasting, or the like). Furthermore, the antenna 72 is allowed to comply with a plurality of communication systems. As illustrated in FIG. 15, each of the end portion 13d of the wall 3k and an end portion 13e opposite the end portion 13d is provided with an opening 13h (a second opening). An opening 3v (a first opening) and the opening 13h oppose each other and provided in line symmetry with respect to a line C positioned at the center of the wall 3k in the lateral direction in FIG. 15. Each of the antennas 72 overlaps with either one of the openings 3v and 13h in the thickness direction of the casing 3B. In addition, in the present modification, an end portion 3m1 (the end portion, the edge portion, the outside portion) of the wall 3m is composed of a material lower in conductivity than a center portion 3m2 (the intermediate portion, the inside portion) of the wall 3m. That is, the center portion 3m2 is composed of a material higher in conductivity than the end portion 3m1. As one example, the end portion 3m1 can be made of a synthetic resin material and the center portion 3m2 can be made of a metallic material. The end portions 3m1 and the center portion 3m2 are integrally formed by way of uneven surfaces. The wall 3m can be formed by insert molding. Here, the end portion 3m1 may be provided extending over the entire circumference of the center portion 3m2 so that the outer circumference of the center portion 3m2 is surrounded by the end portion 3m1, and may be partially provided on the entire circumference of the center portion 3m2. The antenna 72 overlaps with the end portion 3m1 in the thickness direction of the casing 3B. When the wall 3k, 3m, 3n, or the like surrounding (covering) the antennas 72 is composed of a conductive material such as a metallic material, the wall 3k, 3m, 3n, or the like serves as an electromagnetic shield and hence, there exists a possibility that the communication performance of the antenna 72 is lowered. In this regard, in the present modification, as one example, the opening 3v or 13h provided to the wall 3k and the antenna 72 overlap with each other in the thickness direction of the casing 3B and hence, the communication performance of the antenna 72 is hardly lowered. Furthermore, the openings 3v and 13h are provided to the end portions 13d and 13e opposed to each other. Therefore, as one example, a plurality of antennas 72 are easily arranged in a spaced-apart manner from each other. Therefore, as one example, space diversity caused by the antennas 72 is easily obtained. Furthermore, as one example, mutual interference between the antennas 72 is easily suppressed. Here, it is unnecessary that the whole area of the antenna 72 overlaps with the opening 3v or 13h as viewed in a plan view (as viewed in the thickness direction of the casing 3B).

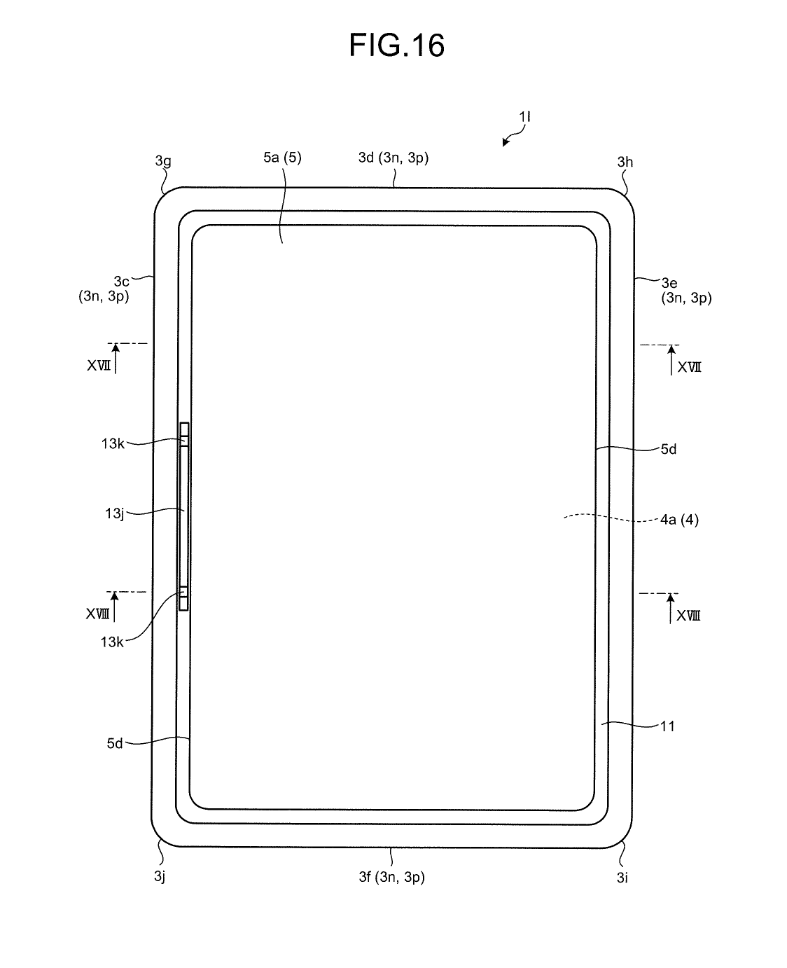

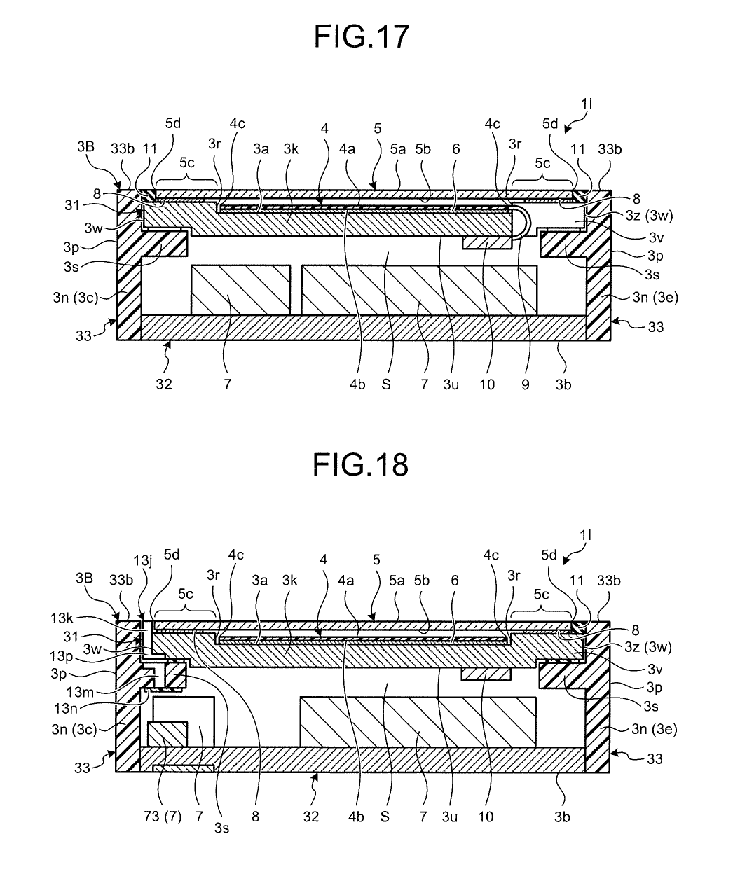

An electronic device 1I according to a seventh modification of the second embodiment illustrated in FIGS. 16 to 18 provides substantially the same configuration as in the above-mentioned embodiments or modifications. Therefore, due to the present modification also, it is possible to obtain substantially the same manner of operation and results (advantageous effects) based on substantially the same configuration. However, in the present modification, the configuration of walls 3k and 3n differs from the above-mentioned embodiment or modifications. That is, a wall 3k has an exposed portion 13j. The wall 3k is composed of a conductive member. The exposed portion 13j is exposed at least partially from the outer circumferential side of a display 4 and members 5 and 6 to the outside of a casing in front of faces 4a and 5a. In the present modification, as one example, the exposed portion 13j is provided along the intermediate portion of the end portion 3c. The exposed portion 13j is exposed from a clearance between the end portion 5d (the periphery portion) of a member 5 and the wall 3n. Furthermore, in the clearance between the end portion 5d and the wall 3n, a sealing member 11 (a sealing portion, a suppression portion) is located in a region other than the exposed portion 13j. The sealing member 11 is linearly formed along the clearance. The sealing member 11 can be a member having elasticity and an insulation property (an elastomer having the insulation property, for example). The exposed portion 13j is provided with an opening 13k (a third opening) extending over between the outside of the casing and the inside of the casing. Furthermore, an opening 13m is provided at a position of a projecting portion 3s (the wall 3n) overlapping with (leading to, communicating with) an opening 13k. The opening 13m is provided extending over between an opening 13k side and a housing chamber S side. Each of the openings 13k and 13m can be a through hole, a notch, a slit, a groove, or the like. Furthermore, each of the openings 13k and 13m can be covered with a porous member 13n (a porous portion, a suppression portion, a barrier, or a buffer; that is, sponge or the like). As the porous member 13n, for example, it is possible to select a material that allows sounds to pass therethrough and is impermeable to dust and water. Furthermore, in the inside of the casing 3B that faces the opening 13m, a microphone unit 73 is located. The exposed portion 13j and the sealing member 11 are dyed with the same color or similar color (black, as one example). The front side (upper side in FIG. 18) part of the exposed portion 13j; that is, the part of the exposed portion 13j exposed to the outside of the casing is painted, and the rear side (lower side in FIG. 18) part of the exposed portion 13j; that is, the part of the exposed portion 13j unexposed to the outside of the casing is not painted. A conductive part 13p of the wall 3k faces (opposes, is exposed to, appears in) the opening 13k at the back side of an opening end. The specifications (position, width, or the like) of the conductive part 13p can be optionally set depending on a painting area. In the present modification described above, the clearance between the end portion 5d of the member 5 and the wall 3n is filled with the sealing member 11. Therefore, as one example, sealing properties with respect to a liquid, a gas, or the like in the clearance is easily improved. Furthermore, in the present modification, the wall 3k has the exposed portion 13j exposed to the outside of the casing in front of the face 5a from the clearance. Therefore, as one example, the opening 13k or the like can be formed using the exposed portion 13j. The openings 13k and 13m can be the passage of sounds to the microphone unit 73. In addition, in the present modification, as one example, the conductive part 13p of the exposed portion 13j (the wall 3k, a first member 31) faces the inside of the opening 13k. Due to such a configuration, the flow of electricity (sparks, surface currents, or the like) into the inside of the casing through the opening 13k is easily suppressed. Therefore, as one example, the protective properties of the components 7 such as the microphone unit 73 are easily improved.

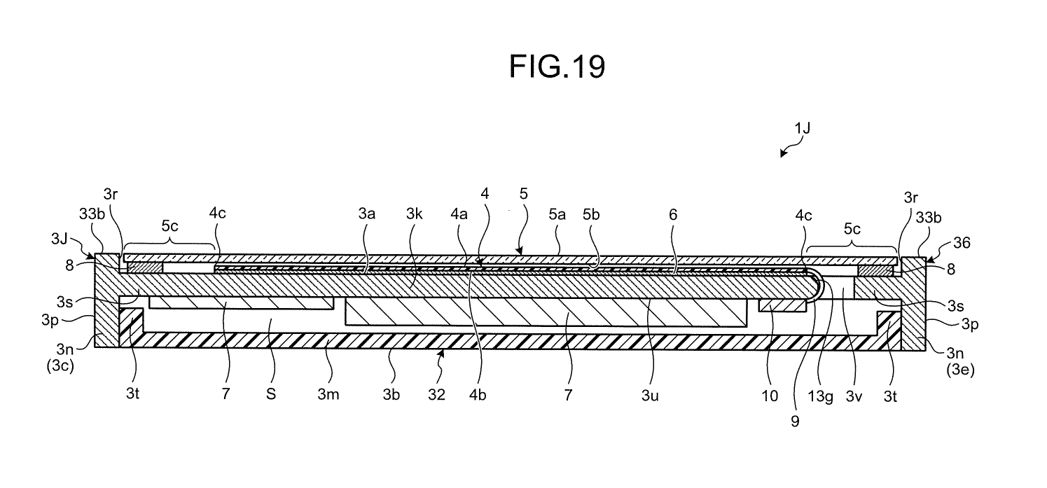

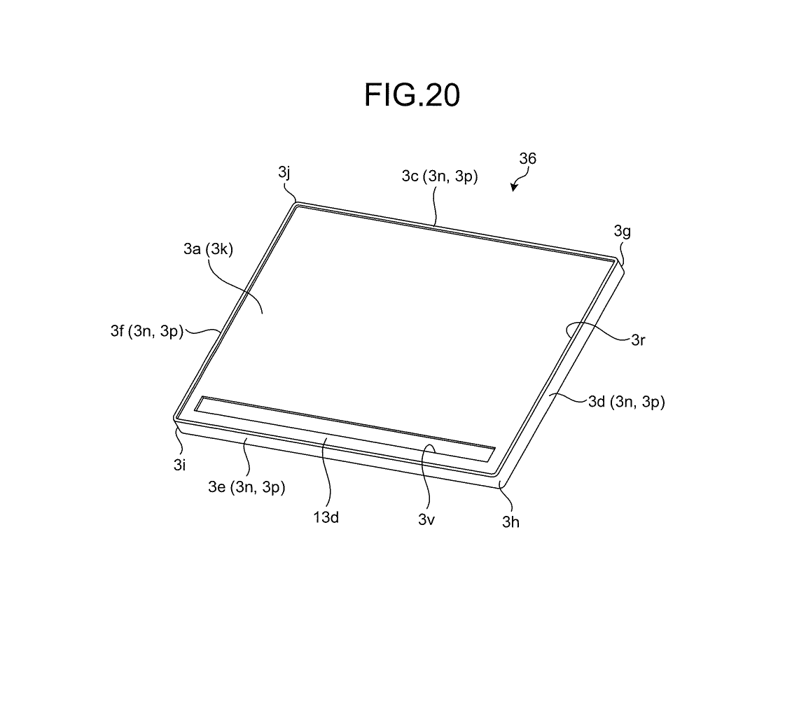

An electronic device 1J according to a third embodiment illustrated in FIGS. 19 and 20 provides substantially the same configuration as in the above-mentioned embodiments or modifications. Therefore, due to the present embodiment, it is possible to obtain substantially the same manner of operation and results (advantageous effects) based on substantially the same configuration. However, the present embodiment differs from the above-mentioned embodiments or modifications in that a casing 3J has a member 36 having a wall 3k and a wall 3n. That is, the casing 3J has the member 36 formed by integrating the members 31 and 33 of the casings 3A and 3B according to the above-mentioned embodiments or modifications. Therefore, according to the present embodiment, as one example, a number of components and man-hours for joining the members 31 and 33 are easily reduced. Furthermore, as one example, the rigidity or the strength of the casing 3J is easily improved. The member 36 is, as one example, composed of a metallic material. The wall 3k is provided with an opening 3v as a through hole. The opening 3v is located close to the end portion 13d (the end portion 3e, the wall 3n) of the wall 3k. The opening 3v extends along the end portion 13d (the end portion 3e, the wall 3n) in a linear manner (a slit-like manner). In addition, in the present embodiment also, at least a part of the components 7 is mounted on (fixed to) the wall 3k.

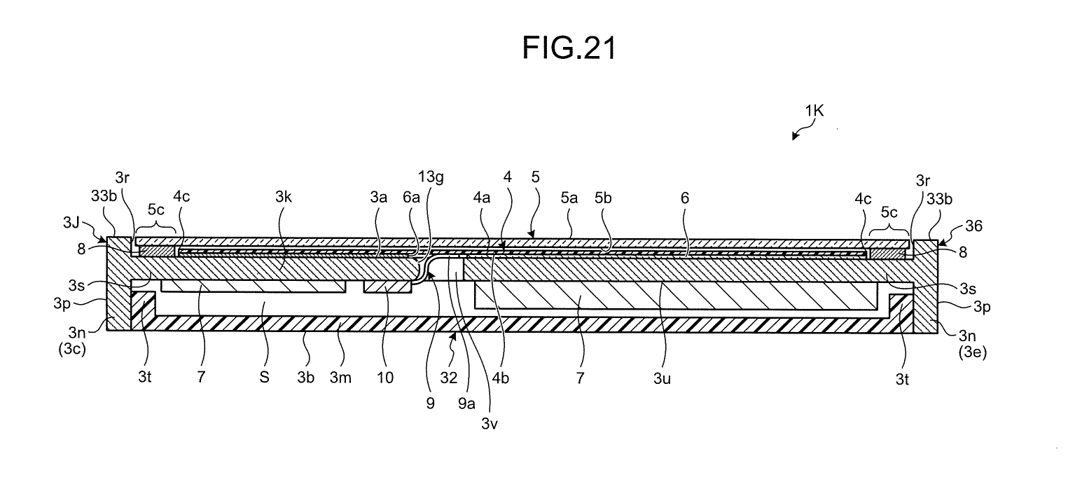

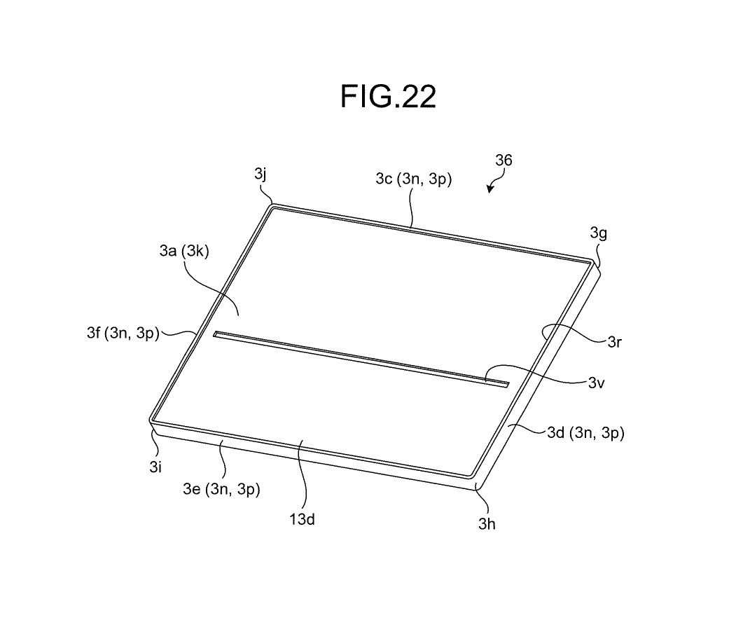

An electronic device 1K according to a first modification of the third embodiment illustrated in FIGS. 21 and 22 provides substantially the same configuration as in the above-mentioned embodiments or modifications. Therefore, due to the present modification also, it is possible to obtain substantially the same manner of operation and results (advantageous effects) based on substantially the same configuration. However, the present modification differs from the above-mentioned embodiments or modifications in that a flat cable 9 is joined to the face 4b (the rear face) of a display 4. That is, an end portion 9a of the flat cable 9 and the face 4b of the display 4 are joined to each other by thermo-compression bonding or the like. The end portion 9a and the face 4b are joined to each other in a state that an electrode (not illustrated in the drawings) exposed on the end portion 9a and an electrode (not illustrated in the drawings) exposed on the face 4b corresponding to the end portion 9a are electrically connected with each other. A wall 3k is provided with an opening 3v at a position corresponding to the flat cable 9. Therefore, as illustrated in FIGS. 21 and 22, there also exists the case that the opening 3v is provided at a position distant from the end portions 3c to 3f of the wall 3k (a wall 3n). A member 6 is provided with an opening 6a through which the flat cable 9 passes. According to the present modification, as one example, compared with the case that the flat cable 9 is taken out (projected) on the periphery side of the display 4, an area of the casing 3J on the periphery side of the display 4 is easily narrowed. That is, considering the same-size casing 3J, the display 4 easily becomes larger compared with the case that the flat cable 9 is taken out (projected) on the periphery side of the display 4. That is, the width of what is called a frame area easily becomes smaller. Furthermore, an area 5c provided to a member 5 easily becomes narrower.

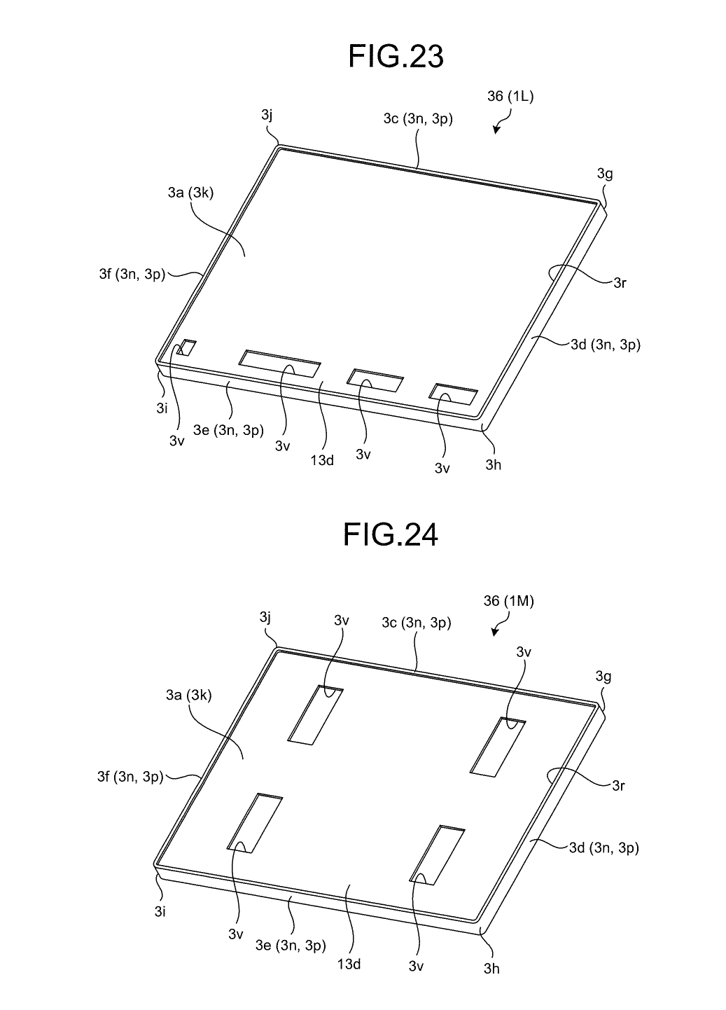

An electronic device 1L according to a second modification of the third embodiment illustrated in FIG. 23 provides substantially the same configuration as in the above-mentioned embodiments or modifications. Therefore, due to the present modification also, it is possible to obtain substantially the same manner of operation and results (advantageous effects) based on substantially the same configuration. However, in the present modification, the specifications (the number, the shape, the position, or the like) of an opening 3v differ from those in the above-mentioned embodiments and modifications. That is, in the present modification, a plurality of openings 3v are provided. Furthermore, the specifications (the size, the area, the length, the position, or the like) of the respective openings 3v also differ from each other. According to the present modification, as one example, unnecessary openings 3v are easily decreased in number. Therefore, as one example, the rigidity of a wall 3k is easily improved.

An electronic device 1M according to a third modification of the third embodiment illustrated in FIG. 24 provides substantially the same configuration as in the above-mentioned embodiments or modifications. Therefore, due to the present modification also, it is possible to obtain substantially the same manner of operation and results (advantageous effects) based on substantially the same configuration. However, in the present modification, the specifications (the number, the shape, the position, the arrangement, or the like) of a plurality of openings 3v differ from those in the above-mentioned embodiments and modifications. According to the present modification, various modifications with respect to the position, the extending direction, or the like of a flat cable 9 can be made. Furthermore, according to the present modification, as one example, unnecessary openings 3v are easily decreased in number. Therefore, as one example, the rigidity of a wall 3k is easily improved.

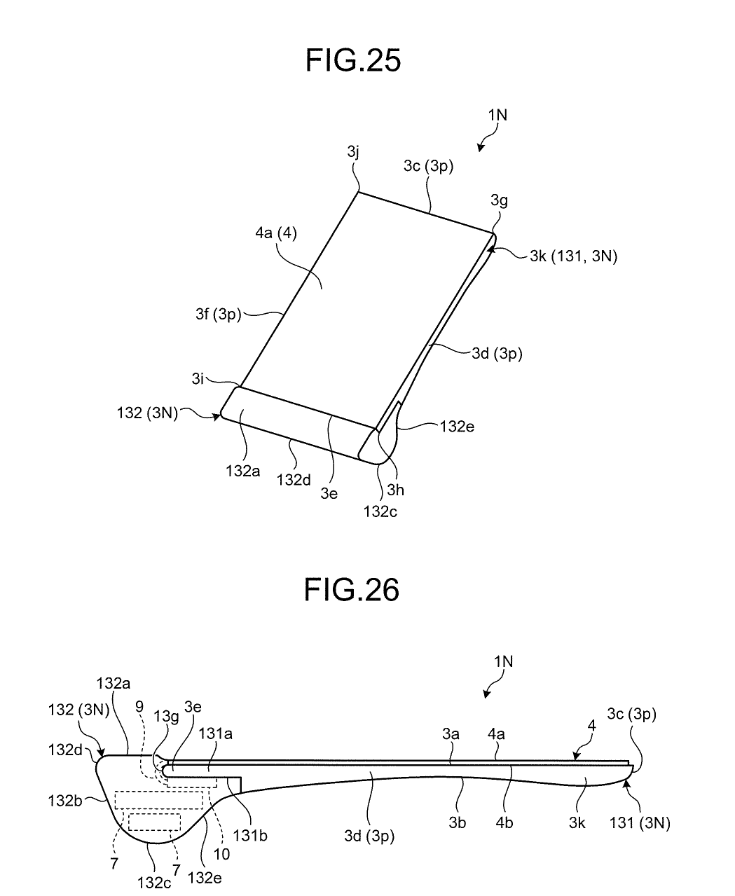

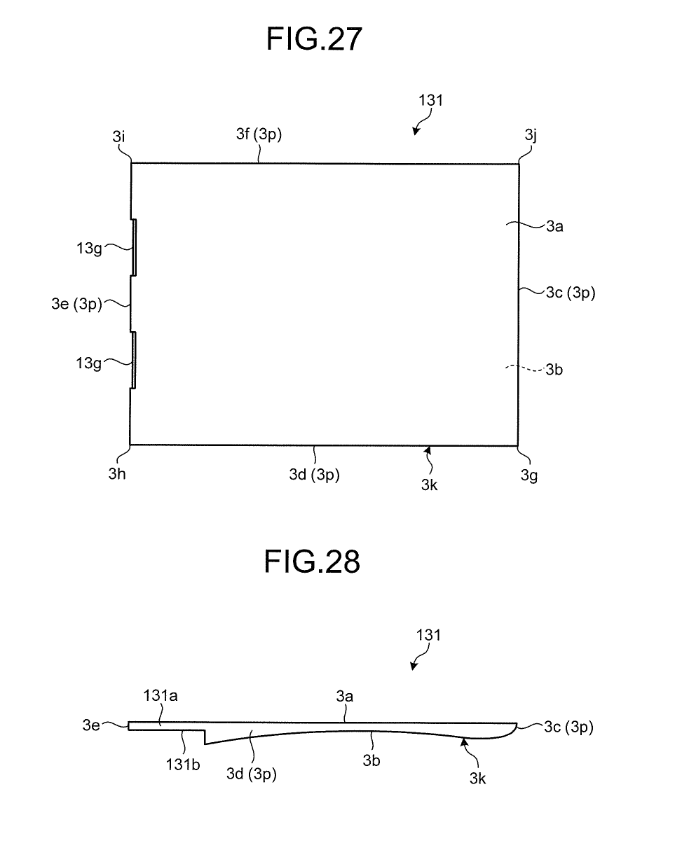

An electronic device 1N according to a fourth embodiment illustrated in FIGS. 25 to 29 provides substantially the same configuration as in the above-mentioned embodiments or modifications. Therefore, due to the present modification also, it is possible to obtain substantially the same manner of operation and results (advantageous effects) based on substantially the same configuration. However, in the present modification, the configuration of a casing 3N differs from the above-mentioned embodiments or modifications. That is, in the present modification, as one example, the casing 3N has a part 131 (a support) and a part 132 (a component housing, a grip portion, a holder, a cover). The part 131 covers the face 4b of a display 4 to support the display 4. The display 4 can be joined (connected, fixed) to the part 131 by bonding, for example. The display 4 can incorporate a touch panel (an in-cell touch panel) therein. The part 132 houses components 7 except for the display 4. Each of the parts 131 and 132 can be configured by one member or a plurality of members combined with each other. Each of the parts 131 and 132 can be configured in a solid shape or in a hollow shape. Furthermore, each of the parts 131 and 132 can be, for example, composed of a metallic material, a synthetic resin material, or these materials combined with each other.

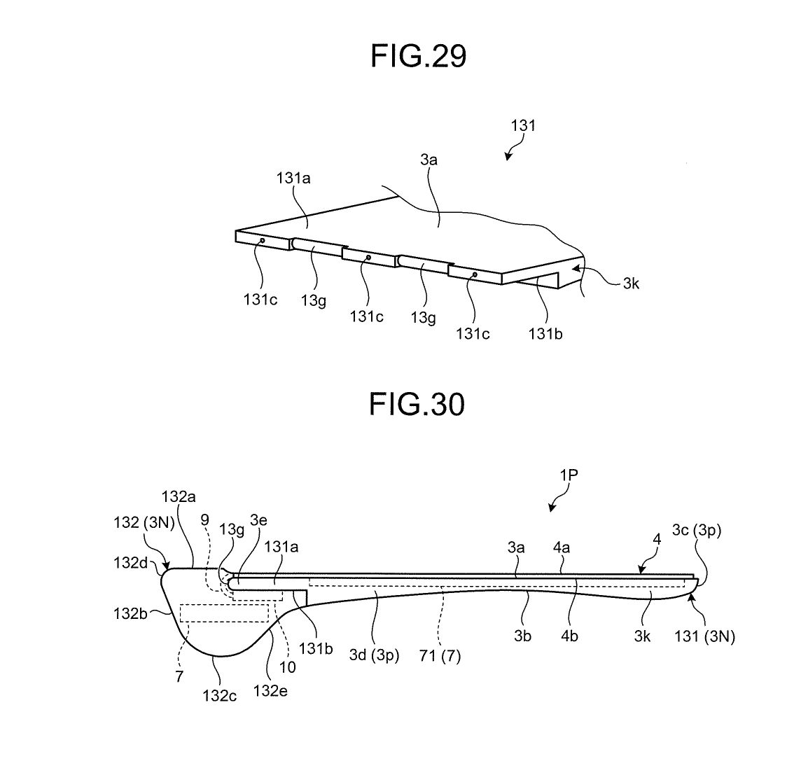

The part 131 is configured in a flat rectangular parallelepiped-like shape whose thickness is decreased in the front-back direction (in the thickness direction of the casing 3N). The part 131 has faces 3a, 3b, and 3p, end portions 3c to 3f, and corner portions 3g to 3j. When the part 131 is configured by one member, the part 131 has a wall 3k. Furthermore, the part 132 is connected to the end portion 3e of the part 131 and extends in a rod-like shape (a columnar shape, a cylindrical shape) along the end portion 3e. The part 132 has a face 132a, a face 132b, a curved portion 132c, a corner portion 132d, and the like. The face 132a is formed in a planar shape and arranged substantially in parallel with the face 3a of the part 131 or the face 4a of the display 4. The face 132b is formed in a planar shape and intersects with the face 132a at an acute angle. The curved portion 132c has a face 132e (a curved face) curved in an S-shape. The face 132e is smoothly connected to the face 3b of the part 131. In addition, the part 131 is joined (connected, fixed) to the part 132 in a state that a portion (a projecting portion 131a provided to the end portion 3e) thereof is inserted in the part 132. The part 131 and the part 132 can be integrated by bonding with the use of fasteners (screws or the like, not illustrated in the drawings), integral molding (insert molding), or the like. When the fasteners are used, as illustrated in FIG. 29, a fastening portion 131c (an internal thread hole, for example) to which each fastener is fastened is provided to the end portion 3e of the part 131 at a position spaced apart from the rounded portion 13g. The part 132 covers a driver board 10. Therefore, the part 132 configures one example of a cover.

In the present embodiment also, in the same manner as in the above-mentioned embodiments, the driver board 10 is mounted on a side of the part 131 (the support) opposite the display 4. To be more specific, the driver board 10 is mounted on a face 131b of the projecting portion 131a opposite the face 3a by bonding, for example. A flat cable 9 that electrically connects the display 4 and the driver board 10 with each other is bent at a position spaced apart from the end portion 3e on the outside of the end portion 3e of the part 131. The rounded portion 13g is provided at a position of the end portion 3e corresponding to the flat cable 9.

According to the present embodiment, as one example, it is possible for a user to hold the part 132 with one hand and operate a touch panel with the other hand. Due to the above-mentioned constitution (shape), the part 132 is easy to hold. Furthermore, in the present embodiment, when the part 131 has flexibility, the part 131 as well as the display 4 can be used while being bent.

An electronic device 19 according to a first modification of the fourth embodiment illustrated in FIG. 30 provides substantially the same configuration as in the above-mentioned embodiments or modifications. Therefore, due to the present modification also, it is possible to obtain substantially the same manner of operation and results (advantageous effects) based on substantially the same configuration. However, the present modification differs from the above-mentioned embodiments or modifications in that a battery 71 is provided in the inside of a part 131. The part 131 may be formed in a hollow shape or in a solid shape. According to the present modification, the battery 71 having larger capacity is easily mounted.

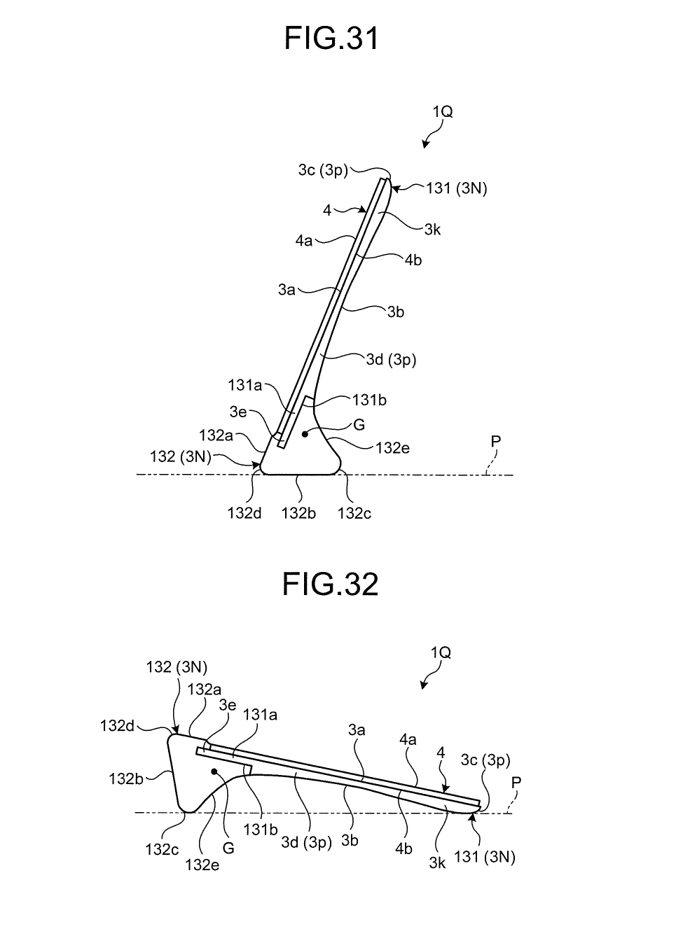

An electronic device 1Q according to a second modification of the fourth embodiment illustrated in FIGS. 31 and 32 provides substantially the same configuration as in the above-mentioned embodiments or modifications. Therefore, due to the present modification also, it is possible to obtain substantially the same manner of operation and results (advantageous effects) based on substantially the same configuration. However, in the present modification, the shape (the appearance) of a part 132 differs from the above-mentioned embodiments or modifications. That is, in the present modification, a face 132b has larger area and hence, as illustrated in FIG. 31, the electronic device 1Q can be used in a state in which the electronic device 1Q is stood up (a posture, an stand-up posture, a raised posture, a vertical posture). In a state illustrated in FIG. 31, the face 132b assumes the role of a bottom face (an abutment face, a support face) placed on (in contact with) a planar surface P (a mounting surface), and the part 132 assumes the role of a support (a leg portion, a stand, a pedestal, abase) on which the electronic device 1Q is supported. In the present modification, as one example, the center of gravity G of the electronic device 1Q is positioned within the area of the part 132. Therefore, as one example, the electronic device 1Q is easy to maintain in a stably-stood-up state.

Furthermore, in the present modification, as illustrated in FIG. 32, the electronic device 1Q can be used in a state that the part 132 and the end portion 3c of the part 131 are supported on the planar face P so that the electronic device 1Q lies (a posture, a lying-down posture, a laterally-placed posture, a lateral posture). In a state illustrated in FIG. 32, a part 132 (end portion 3e) side is larger in height than the end portion 3c side. The electronic device 1Q has an attitude sensor (an acceleration sensor, a gyroscope, or the like), and a controller rotates images on the display 4 in the direction opposite to the case illustrated in FIG. 31 (in upside down direction). In this manner, according to the present modification, the electronic device 1Q can be used in a posture in which the user holds the electronic device 1Q by hands, a posture illustrated in FIG. 31, and also a posture of FIG. 32.

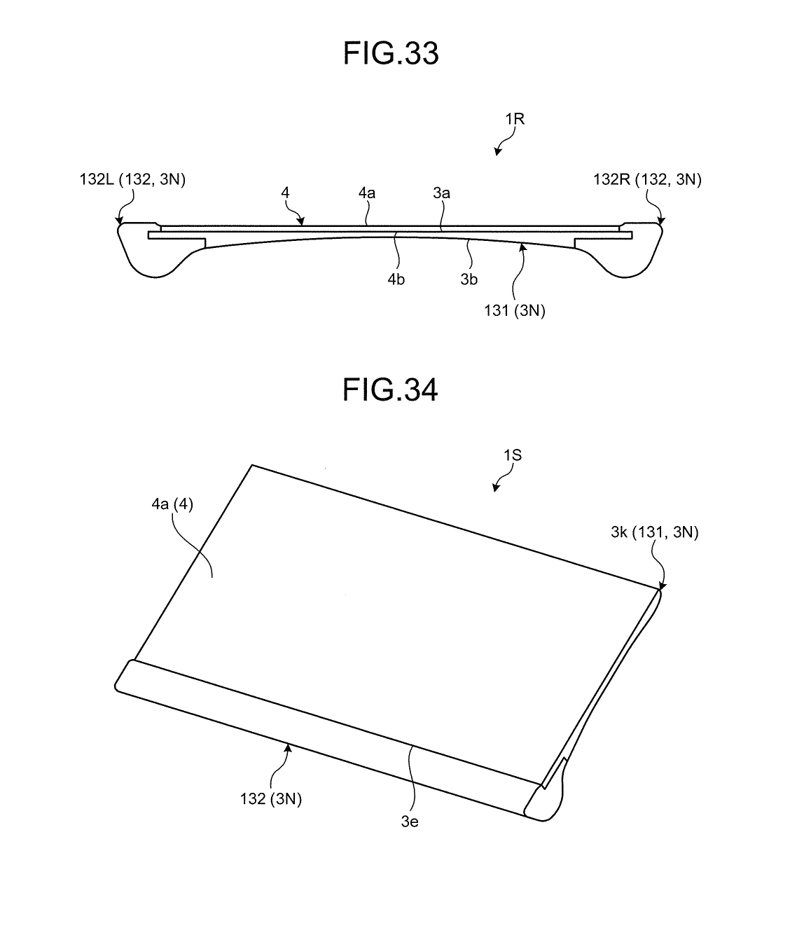

An electronic device 1R according to a third modification of the fourth embodiment illustrated in FIG. 33 provides substantially the same configuration as in the above-mentioned embodiments or modifications. Therefore, due to the present modification also, it is possible to obtain substantially the same manner of operation and results (advantageous effects) based on substantially the same configuration. However, the present modification differs from the above-mentioned embodiments or modifications in that parts 132 are provided to both sides of a part 131 in the longitudinal direction. In such a constitution, as one example, a battery 71 as a component 7 can be housed in one (a part 132R) of the parts 132 and a board assembly 70 as the component 7 can be housed in the other part 132 (a part 132L). In this case, the part 132R can be connected to the part 131 in a detachable manner. Due to such a configuration, the battery 71 is easily replaced. Furthermore, the part 132R per se can be configured as a battery (a battery pack, a battery module, a cell). Furthermore, according to the present modification, the electronic device 1R is easy to use while holding the both side parts 132 in the longitudinal direction thereof. Here, the parts 132 may be provided to both sides of the part 132 in the transverse direction. In addition, according to the present modification also, it is possible to impart flexibility to the part 131.

An electronic device 1S according to a fourth modification of the fourth embodiment illustrated in FIG. 34 provides substantially the same configuration as in the above-mentioned embodiments or modifications. Therefore, due to the present modification also, it is possible to obtain substantially the same manner of operation and results (advantageous effects) based on substantially the same configuration. However, in the present modification, a part 132 is joined (connected, fixed) to the end portion 3e of a part 131 in the transverse direction. According to the present modification, as one example, the electronic device 1S is conveniently used when viewing a screen in a landscape-oriented state.

The embodiments and modifications, which have been exemplified, are illustrated by way of example only and are not intended to limit the scope of the present invention. These embodiments and modifications can be made in various other configurations. Various omissions, replacements, combinations, or alterations can be made without departing from the spirit of the present invention. These embodiments and modifications are included in the scope or the spirit of the present invention, and included in the invention described in the accompanying claims and in the range where these embodiments and modifications are considered equivalent to the present invention. Furthermore, the technical features of the above-mentioned respective embodiments and modifications can be achieved by partially combining or replacing the components as appropriate. In addition, the specifications of each constitution or shape (structures, kinds, directions, shapes, sizes, lengths, widths, thicknesses, heights, numbers, arrangements, positions, materials, or the like) can be changed as appropriate.

Moreover, the various modules of the systems described herein can be implemented as software applications, hardware and/or software modules, or components on one or more computers, such as servers. While the various modules are illustrated separately, they may share some or all of the same underlying logic or code.

What is claimed is:

1. A television receiver comprising:
a display with a bendable sheet-like shape comprising a front face at which an image is viewable and a rear face opposite the front face;
a casing comprising
a first wall configured to support the display and cover the rear face,
a second wall positioned at a side of the first wall opposite the display and positioned apart from the first wall, and
a third wall extending between a periphery of the first wall and a periphery of the second wall; and
a driver board of the display, the driver board being provided to the first wall at a side opposite the display, the driver board being electrically connected to the display via a flat cable.

2. The television receiver of claim 1, wherein the first wall is provided with a first opening through which the flat cable passes.

3. The television receiver of claim 2, wherein a rounded portion formed in a shape along a curvature of the flat cable is provided to an edge of the first opening.

4. The television receiver of claim 2, wherein
an antenna is provided inside the casing, and
a second opening provided to the first wall and the antenna overlap each other in a thickness direction of the casing.

5. The television receiver of claim 4, wherein the first opening is positioned at an end portion at one side of the first wall, and at least one of the second openings is positioned at an end portion at other side of the first wall.

6. The television receiver of claim 1, wherein the flat cable is joined to the rear face.

7. The television receiver of claim 1, wherein the first wall is configured by a conductive member, and comprises an exposed portion exposed to outside of the casing at a front side of the front face and at outside of the periphery of the front face.

8. The television receiver of claim 7, wherein
a third opening extending from inside of the casing to outside of the casing is provided to the exposed portion, and
a conductive part of the first wall is configured to face at least a portion of the third opening.

9. An electronic device comprising:
a display with a sheet-like shape comprising a front face at which an image is viewable and a rear face opposite the front face;
a casing configuring a housing chamber in which a component is housed;
a wall configured to be a portion of the casing and to support the rear face of the display; and
a board configured to be provided to a side of the wall portion opposite the display and electrically connected to the display via a flat cable.

10. An electronic device comprising:
a display with a sheet-like shape comprising a front face at which an image is viewable and a rear face opposite the front face;
a support configured to support the display and cover the rear face, a portion of the support being exposed;
a board configured to be provided to the support at a side opposite the display and electrically connected to the display via a flat cable; and
a cover configured to be provided to one end side of the support and cover the board.

11. The electronic device of claim 10, wherein at least the exposed portion of the support has flexibility.
